(19) United States
(12) Patent Application Publication
(10) Pub. No.: US 2017/0108222 A1
(43) Pub. Date: Apr. 20, 2017

(54) VARIABLE ANGLE SPRAY CONE INJECTION

(71) Applicant: Delavan Inc, West Des Moines, IA (US)

(72) Inventors: Jason A. Ryon, Carlisle, IA (US); Philip E. Buelow, West Des Moines, IA (US); John E. Short, Norwalk, IA (US)

(73) Assignee: Delavan Inc, West Des Moines, IA (US)

(21) Appl. No.: 14/885,314

(22) Filed: Oct. 16, 2015

(51) Int. Cl. F23R 3/28; H01M 8/04082; F01N 3/20

(52) U.S. Cl. CPC F23R 3/28; F01N 3/206; H01M 8/04201

(57) ABSTRACT

A method of issuing a spray cone from a nozzle includes modulating flow to two separate first and second fluid circuits, each connected to a common injection point orifice to vary spray angle on a substantially hollow spray cone over time to create a full spray cone. Modulating can include controlling first and second flow modulators, connected to the first and second fluid circuits, respectively, to coordinate oscillating flow rate modulation of both of the first and second fluid circuits. Controlling can include controlling the oscillating flow rate modulation for the first flow modulator to be out of phase with, to be in antiphase with, to be vertically shifted in magnitude relative to, and/or to have an amplitude that is equal to that of the second flow modulator.

### BACKGROUND OF THE INVENTION

1. Field of the Invention

The present disclosure relates to injectors, and more particularly to injection such as used in fuel injectors for gas turbine engines, exhaust gas after treatment, fuel cell reformers, and the like.

2. Description of Related Art

A variety of devices are known for injecting or spraying liquids, and for atomizing liquids into sprays of fine droplets, such as for gas turbine engines, fuel cell reformers, fire sprinkler systems, agricultural sprayers, chemical processing, paint sprayers, and other similar applications. It is desirable in many applications for the spray angle of a nozzle or injector to change during operation. For example, during start up of a gas turbine engine, it is desirable for fuel nozzles to have a wide spray angle in order to position fuel flow in proximity with igniters, which are typically on the periphery of the surrounding combustor. After combustion has been initiated, it may be desirable to have a narrower spray angle to achieve deeper spray penetration into the combustor. These two different spray angles can be accomplished using nozzles with two stages, each having a different spray angle. The extra components required to produce the two stages require envelope space and add to part count. It may also be possible to change the spray angle by physically changing the nozzle geometry. This approach has not become main stream, due to the complications of actuating components to change the nozzle geometry.

Such conventional methods and systems have generally been considered satisfactory for their intended purpose. However, there is still a need in the art for improved injection. The present disclosure provides a solution for these problems.

### SUMMARY OF THE INVENTION

A method of issuing a spray cone from a nozzle includes modulating flow to two separate first and second fluid circuits, each connected to a common injection point orifice to vary spray angle on a substantially hollow spray cone over time to create a full spray cone. Modulating can include controlling first and second flow modulators, connected to the first and second fluid circuits, respectively, to coordinate oscillating flow rate modulation of both of the first and second fluid circuits. Controlling can include controlling the oscillating flow rate modulation for the first flow modulator to be out of phase with, to be in antiphase with, to be vertically shifted in magnitude relative to, and/or to have an amplitude that is equal to that of the second flow modulator.

A nozzle system for injecting liquid includes a nozzle body defining a first circuitous flow channel and a swirl ante-chamber in fluid communication with the first flow channel, with an injection point orifice defined in the swirl ante-chamber. The first flow channel feeds into the swirl ante-chamber to impart a tangential flow component on fluids entering the swirl ante-chamber to generate swirl on a spray issuing from the injection point orifice. A second circuitous flow channel is defined in fluid communication with the swirl ante-chamber. The second flow channel feeds into the swirl ante-chamber to impart a tangential flow component on fluids entering the swirl ante-chamber.

A backing member is in fluid communication with the nozzle body. The backing member includes a first fluid inlet chamber having one or more flow passages defined through the backing member for fluid communication from the first fluid inlet chamber of the backing member to the first flow channel of the nozzle body, and a second fluid inlet chamber having one or more flow passages defined through the backing member for fluid communication from the second fluid inlet chamber of the backing member to the second flow channel of the nozzle body to change spray angle of the injection point orifice by apportionment of flow between the first and second fluid inlet chambers of the backing member.

A first flow modulator is included in fluid communication with the first fluid inlet. A second flow modulator is included in fluid communication with the second fluid inlet. The first and second flow modulators are configured to issue an oscillating flow to the first and second fluid inlets, respectively, to issue a full active spray cone from the injection point orifice.

A controller can be operatively connected to the first and second flow modulators to coordinate oscillating flow rate modulation of both. The oscillating flow rate modulation for the first flow modulator can be out of phase, e.g., in antiphase, with the oscillating rate flow modulation for the second flow modulator. The oscillating flow rate modulation for the first flow modulator can be vertically shifted in magnitude relative to the oscillating flow rate modulation for the second flow modulator. The oscillating flow rate modulation for the first flow modulator can have an amplitude that is equal to that of the second flow modulator. It is contemplated that the oscillating flow rate modulation for the first flow modulator can be in antiphase with, can be vertically shifted in magnitude relative to, and can have an amplitude that is equal to that of the second flow modulator.

The flow passages of the first and second flow channels can feed into the swirl ante-chamber to impart a counter-swirling tangential flow component on fluids entering the swirl ante-chamber. It is also contemplated that the flow passages of the first and second flow channels can feed into the swirl ante-chamber to impart a co-swirling tangential flow component on fluids entering the swirl ante-chamber. The nozzle system can include additional swirl ante-chambers, each having a separate injection point orifice, each swirl ante-chamber being in fluid communication with the first and second flow channels.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is an exploded cross-sectional perspective view of a prior art nozzle, showing the nozzle body and backing member separated;

FIG. 2 is a schematic exploded cross-sectional perspective view of an exemplary embodiment of a nozzle system constructed in accordance with the present disclosure, showing two separate flow paths feeding into the swirl ante-chamber for swirl direction control through apportionment of flow between the two flow paths;

FIG. 3 is an inlet end view of the nozzle body of FIG. 2, showing flows leading into the swirl ante-chamber that reduce swirl;

FIG. 4 is a graph showing an exemplary embodiment of a flow modulation technique in accordance with the present disclosure, showing flow modulation to the two fluid circuits in the nozzle of FIG. 2 for developing an active full spray cone between the two spray angles of the nozzle;

FIG. 5 is a schematic cross-sectional side elevation view of a narrow spray cone from the nozzle system shown in FIG. 2;

FIG. 6 is a schematic end view of the spray cone of FIG. 5;

FIG. 7 is a schematic cross-sectional side elevation view of a wide spray cone from the nozzle system shown in FIG. 2;

FIG. 8 is a schematic end view of the spray cone of FIG. 7;

FIG. 9 is a schematic cross-sectional side elevation view of a full spray cone from the nozzle system shown in FIG. 2, extending from the narrow spray cone in FIG. 5 to the wide spray cone in FIG. 7;

FIG. 10 is a schematic end view of the spray cone of FIG. 9;

FIGS. 11, 13, and 15 are schematic side views of a portion of the nozzle system of FIG. 2 in an embodiment with multi-point spray, showing a spray issued at wide, narrow, and full spray angles, respectively; and

FIGS. 12, 14, and 16 are schematic end or cross-sectional views of the sprays of FIGS. 11, 13, and 15, respectively.

### DETAILED DESCRIPTION OF THE PREFERRED EMBODIMENTS

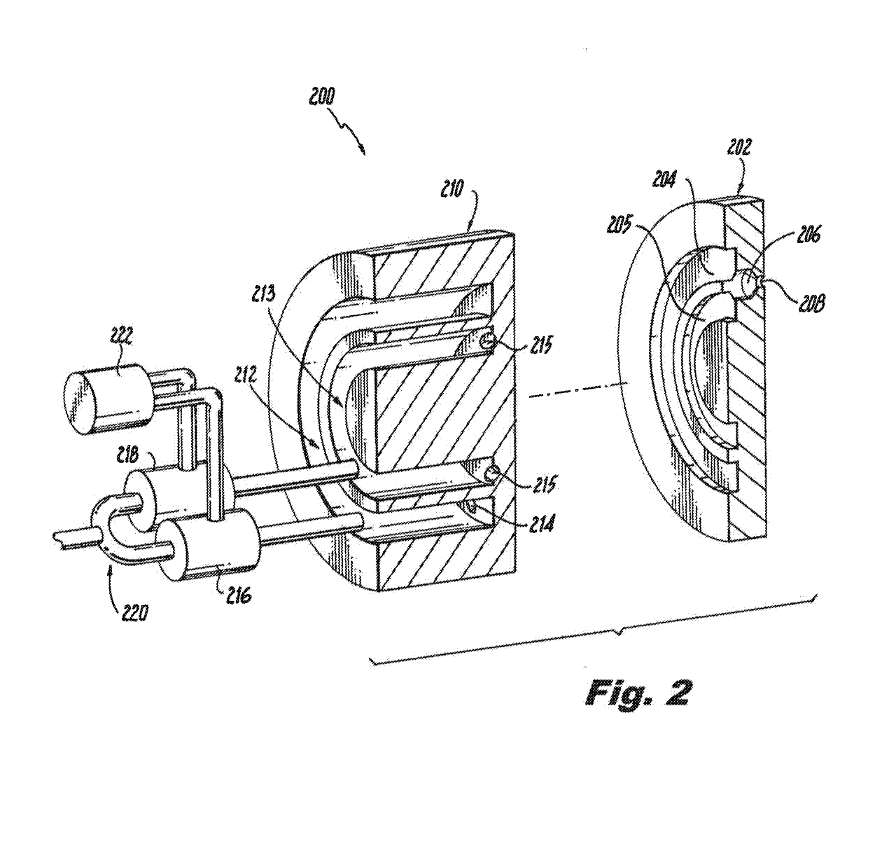

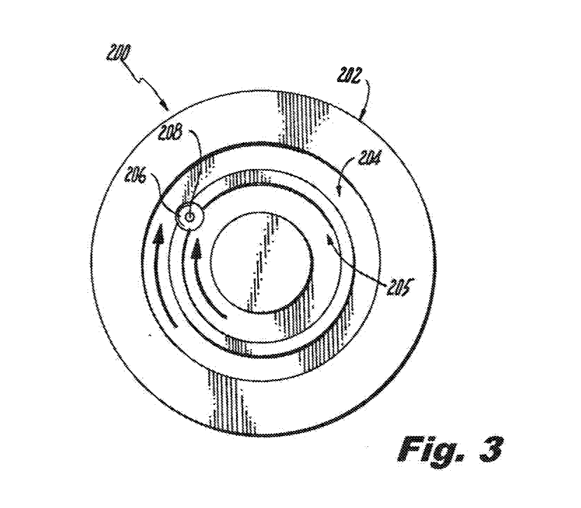

Reference will now be made to the drawings wherein like reference numerals identify similar structural features or aspects of the subject disclosure. For purposes of explanation and illustration, and not limitation, a partial view of an exemplary embodiment of a nozzle system in accordance with the disclosure is shown in FIG. 2 and is designated generally by reference character 200. Other embodiments of nozzle systems in accordance with the disclosure, or aspects thereof, are provided in FIGS. 3-16, as will be described. The systems and methods described herein can be used to provide injection with active full spray cones.

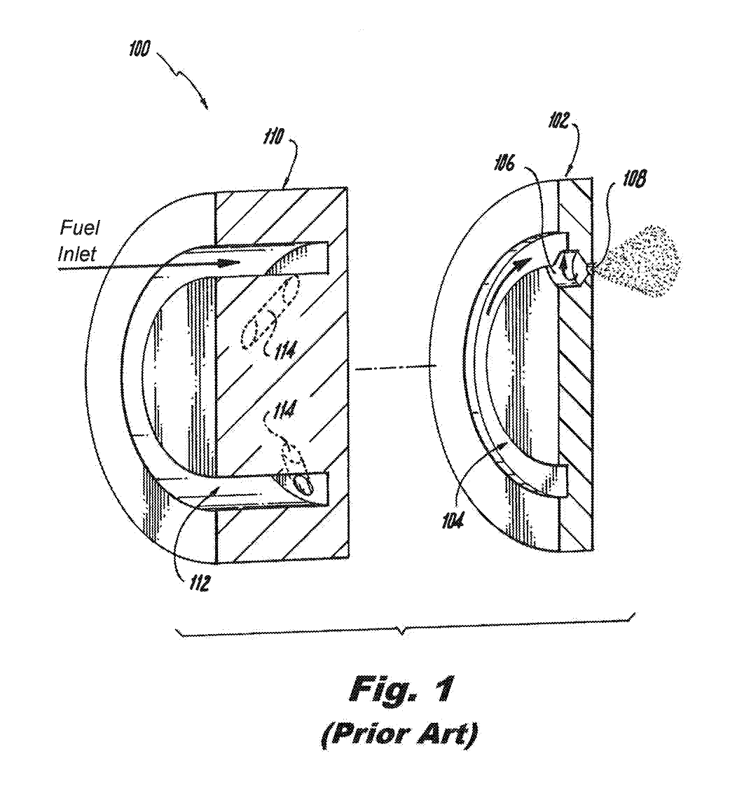

Referring first to FIG. 1, nozzle 100 includes a nozzle body 102 in the form of a plate defining a circuitous flow channel 104 and a swirl ante-chamber 106 in fluid communication with flow channel 104. An injection point orifice 108 is defined in the swirl ante-chamber 106. Flow channel 104 feeds a flow into the swirl ante-chamber 106 in an off-center manner to impart a tangential flow component on fluids entering swirl ante-chamber 106 to generate on a spray issuing from injection point orifice 108. A backing member 110 is mounted to nozzle body 102, e.g., nozzle body 102 is a front plate and backing member 110 is a back plate as oriented in FIG. 1. Backing member 110 includes a fluid inlet chamber 112. The backing member also includes four flow passages 114, two of which are shown schematically in FIG. 1, defined through backing member 110 for fluid communication from fluid inlet chamber 112 to flow channel 104 of nozzle body 102. Passages 114 are angled to impart a direction on flow into flow channel 104, as indicated by the clockwise flow arrow in flow channel 104 of FIG. 1.

This geometry is generalized by geometry in which the liquid is given a directional bias from features in the geometry, i.e., passages 114 which could be holes, slots, or the like, which enter into one or more separate passages, i.e., flow channel 104. The flow feeds from flow channel 104 into swirl ante-chamber 106 with a bias in direction, so as to impart swirl on fluids flowing into swirl ante-chamber 106. The flow continues to spin before finally exiting out of orifice 108. Multiple swirl ante-chambers and respective orifices may be used for multi-point injection. Note that for simplicity only one the fluid circuit is shown in FIG. 1, and other fluid (e.g., fuel/air) circuits are described below.

The configuration in FIG. 1 represents a simplification in swirler geometry compared to conventional swirlers which translates into simplified manufacture. Intricate swirl slots or the like are not required as in traditional swirlers. In a traditional single or multi-point injector, very small passages are utilized to impart swirl into the swirl ante-chamber(s). With nozzle 100, the direction is imparted on the flow by larger features (slots, holes, etc.) and also directed into the swirl ante-chamber 106, with directional bias, which imparts swirl into the flow without the need of very small passages.

With reference now to FIG. 2, using multiple flow channels to feed a swirl ante-chamber allows for fluidic control of spray angle. Nozzle system 200 has a nozzle body 202, backing member 210, flow channel 204, swirl antechamber 206, injection point orifice 208, fluid inlet chamber 212, and passages 214 much as described above with respect to FIG. 1. In addition, nozzle system 200 includes a second annular flow channel 205 inboard of the first flow channel 204. Nozzle system 200 also includes a second fluid inlet chamber 213 inboard of the first inlet chamber 212. Inlet chamber 213 includes passages 215 that can be configured to generate a flow in flow channel 205 that co-swirls or counter-swirls with flow in flow channel 204. Thus the direction of flow in the separate passages as they feed into the swirl ante-chamber may be directed either to aid swirl in the swirl ante-chamber 206 or may weaken the amount of swirl, depending on the respective angles of passages 214 and 215. FIGS. 2-3 only show one swirl ante-chamber 206 and orifice 208 for simplicity, however as will be described below, there are actually four of each, and any suitable number can be used.

With reference now to FIG. 3, the flow directions in flow channels 204 and 205 are indicated in the case where passages 214 and 215 are angled to create counter-swirling flow in swirl ante-chamber 206. In this case, flow apportionment between the two flow channels 204 and 205 can be used to control the spray angle issuing from orifice 208 as follows. If the total flow is apportioned through flow channel 205, with no flow through flow channel 204, a base spray angle will be produced. If flow is apportioned with half of the flow through each channel 204 and 205, then the swirl will be decreased and the spray angle will be narrower than the base spray angle.

Nozzle system 200 provides the advantage of variable swirl angle ability. With two or more channels feeding into the swirl ante-chambers, if the directional geometry is set to counter-swirl into the swirl ante-chambers, for example, there is a large degree of controllability on the swirl angle. For example, fixing the total flow rate into the injector (say 100 lb/hr or 0.756 kg/s), if all of the flow goes through only 1 of the 2 channels, it will give a certain spray angle out of the exit orifice(s), for example 60°. If the flow is split evenly between both channels, e.g., 50 lb/hr (0.38 kg/s) in each channel for 100 lb/hr (0.756 kg/s) total injector flow, then the spray angles out of the exit orifice(s) will be reduced because of the opposite swirl directions feeding into the swirl ante-chambers. This swirl angle can be completely controlled by controlling the flow split between the channels.

Referring again to FIG. 2, a first flow modulator 216 is included in fluid communication with the first fluid inlet, e.g., fluid inlet chamber 212. A second flow modulator 218 is included in fluid communication with the second fluid inlet, e.g., fluid inlet chamber 213. By apportionment of flow from a source, such as manifold 220, first and second flow modulators 216 and 218 can apportion flow between the first and second fluid inlet chambers 212 and 213 of the backing member 210 to vary over time the angle of the spray cone issued from injection point orifice 208. A controller 222 is operatively connected to the first and second flow modulators 216 and 218 to coordinate oscillating flow rate modulation of both. Flow modulator 216, fluid inlet chamber 212, and flow channel 204 form a first fluid circuit, and Flow modulator 218, fluid inlet chamber 213, and flow channel 205 form a second fluid circuit. Flow modulators 216 and 218 can each include respective valves and actuators for opening and closing the valves.

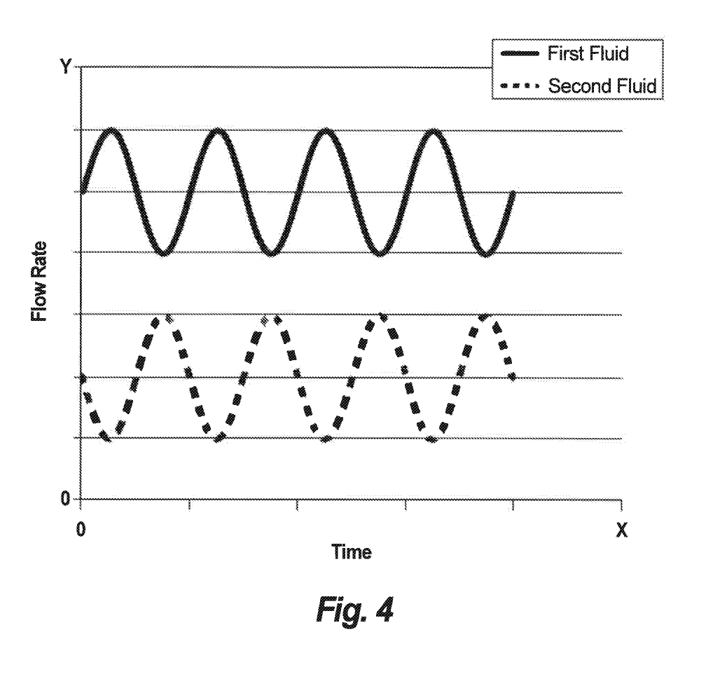

Referring now to FIG. 4, an exemplary fluid modulation technique between the two fluid circuits is shown graphically. The solid curve represents and oscillating flow, modulated by flow modulator 216 in the first fluid circuit, where flow rate from flow modulator 216 is varied as a function of time. The dashed curve similarly represents the oscillating flow modulated by flow modulator 218 in the second fluid circuit. With flow modulators 216 and 218 being controlled to provide the illustrated flow rates, the spray angle of a spray cone issued from 208 of FIG. 2 varies or oscillates as a function of time from a low swirl, narrow cone angle, e.g., at points in time where the two curves in FIG. 4 are closest together, to a higher swirl, wider cone angle, e.g., at points in time where the two curves in FIG. 4 are farthest apart. In this flow modulation scheme, the total flow rate is constant. In this example, the counter-rotational configuration in FIG. 3 is used, however any other suitable flow configuration and modulation can be used without departing from the scope of this disclosure.

In FIG. 4, the oscillating flow rate modulation for the first flow modulator 216 is out of phase, e.g., in antiphase, with the oscillating rate flow modulation for the second flow modulator 218. The oscillating flow rate modulation for the first flow modulator 216 is also vertically shifted in magnitude relative to the oscillating flow rate modulation for the second flow modulator 218, meaning the average flow rate in the first fluid circuit is greater than that of the second. The oscillating flow rate modulation for the first flow modulator 216 has the same amplitude as that of the second flow modulator. Those skilled in the art will readily appreciate that the flow modulation scheme shown in FIG. 4 is exemplary only, and that any other suitable scheme can be used for a given application without departing from the scope of this disclosure. Moreover, while both modulations in FIG. 4 have the same period, those skilled in the art will readily appreciate that different periods can be used without departing from the scope of this disclosure. This modulation scheme can be programmed into controller 222 of FIG. 2 to control the flow modulators 216 and 218, e.g., with machine readable instructions stored in or transmitted to controller 222, to carry out the flow modulation. The frequency of the modulation can be any suitable frequency, however it is contemplated that relatively high frequencies, e.g., 1000 Hz can provide an effectively full spray cone. High speed valves and actuators can be used, and can be kept near the nozzle itself to reduce capacitance issues in the flow.

The flow modulations described above can be modified so the spray can be profiled for specific applications. For example, if a uniform mass distribution is desired, the flow control of the modulation can be biased to spend more time at wider angles than narrow angles. The profile can also be tailored to reduce hot spots, e.g., in combustion applications, and give a better temperature profile at the exit of the combustor, leading to increased engine life. With active fluid control, e.g., from controller 222, the spray angle could be varied instead of the mass flow rate as in traditional active fluid control, to stabilize instabilities in a flame.

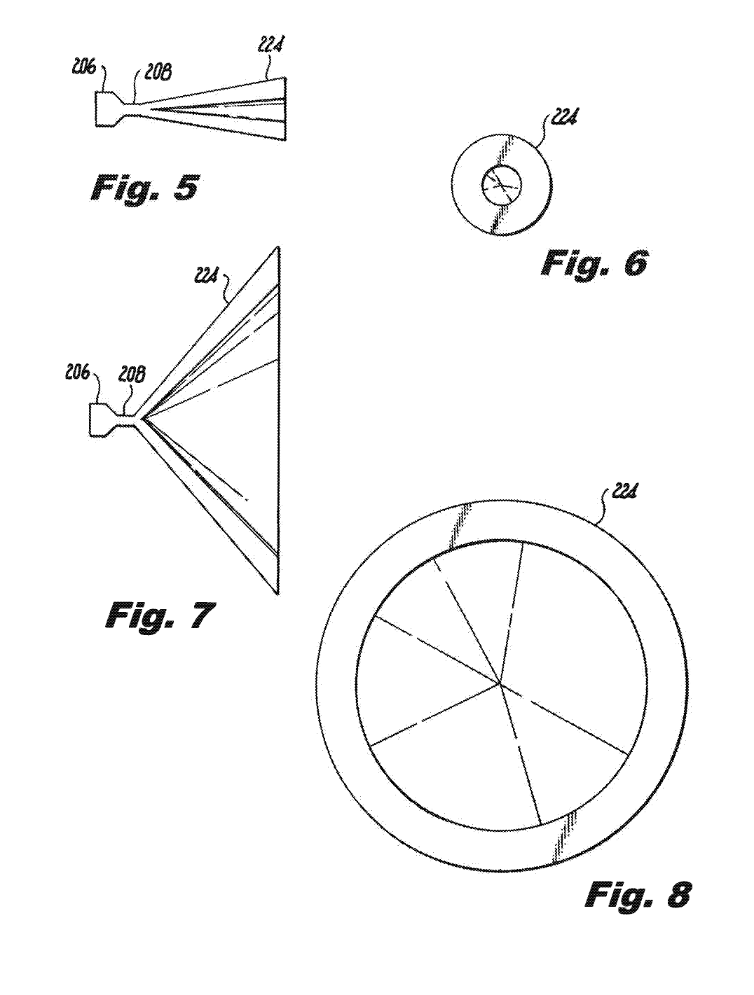

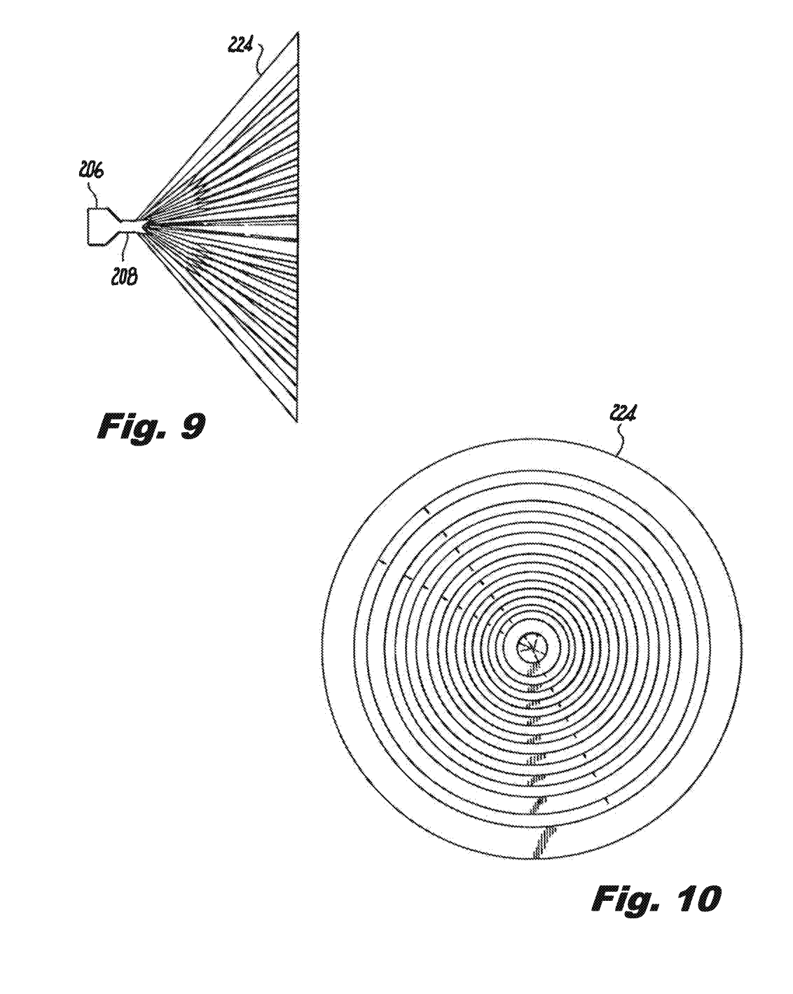

Referring now to FIGS. 5-10, the effects of the flow modulation scheme of FIG. 4 are depicted schematically. FIGS. 5-6 show, respectively, side and end views of a narrow spray cone 224, e.g. at a point in time where the two fluid circuits are modulated to induce less swirl in antechamber 206. FIGS. 7-8 show, respectively, side and end views of a wider spray cone 224, e.g., at a point in time where the two fluid circuits are modulated to induce more swirl in antechamber 206. As can be seen schematically in FIGS. 5-6, the spray cone 224 is substantially hollow regardless of its spray angle. By modulating over time between these two spray angles, using the flow modulation scheme depicted in FIG. 4 for example, the full cone 224 depicted in FIGS. 9 and 10 can be attained as an average spray cone over time. Effectively, the spray cone depicted in FIGS. 9 and 10 is solid, rather than hollow. Those skilled in the art will readily appreciate that while that the spray cones depicted in FIGS. 5-10 are exemplary, and that any other spray angles can be used, including a straight jet spray, without departing from the scope of this disclosure. In short, the first and second flow modulators 216 and 218 are configured to issue an oscillating flow to the first and second fluid inlets, respectively, to issue a full active spray cone 224 from the injection point orifice 208.

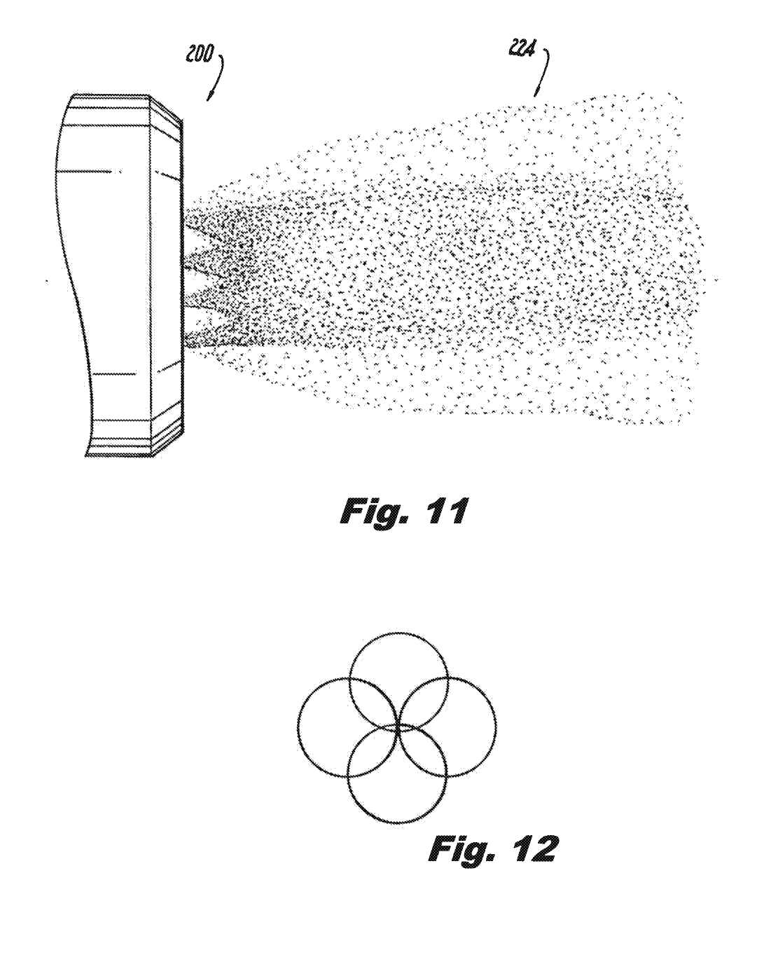

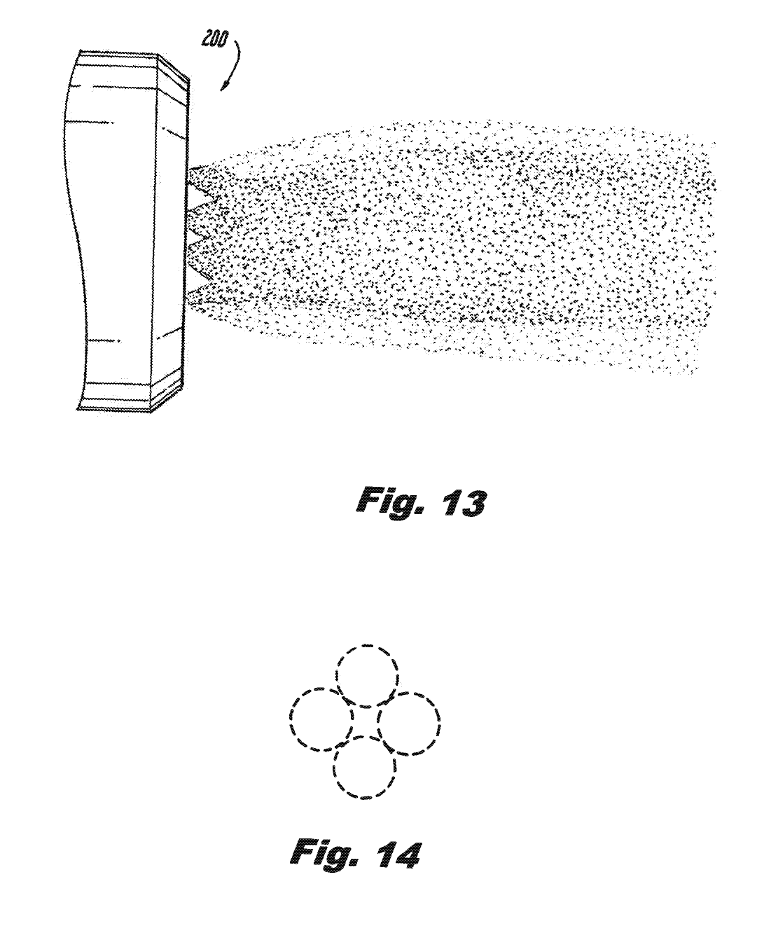

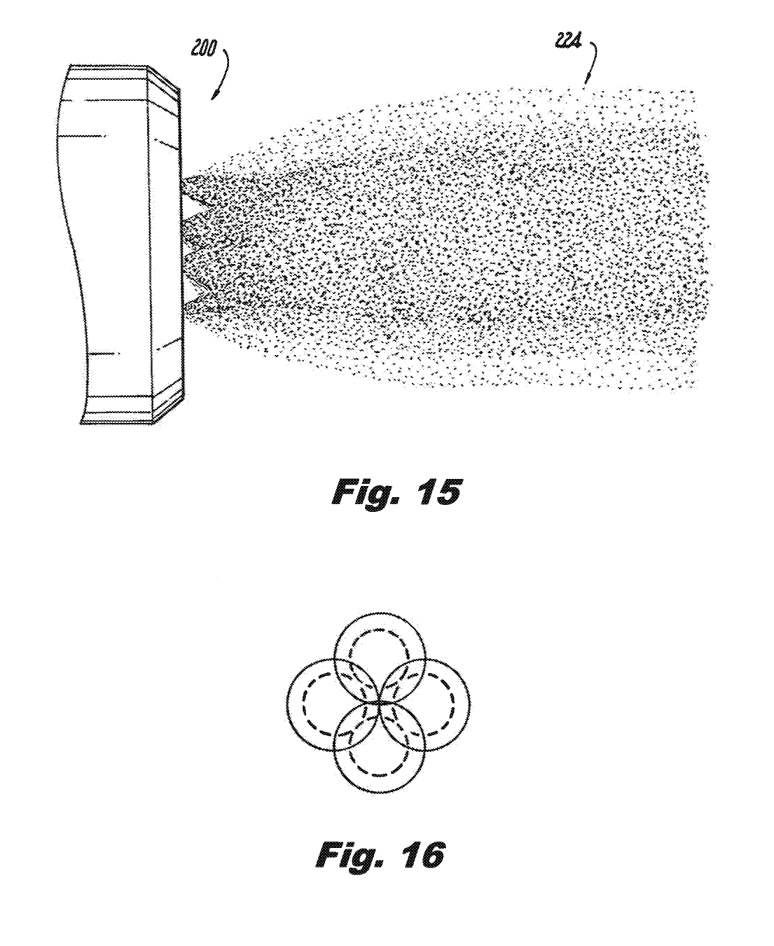

FIGS. 11, 13, and 15 depict with stippling the spray cone angles of the nozzle system 200 shown in FIG. 2, wherein all four injection points are shown. This exemplary geometry has a flow number of roughly 12 with four separate multi-point injection orifices. There is no outlet conic on the injection points, so the images in FIGS. 11, 13, and 15 show the natural cone angles. FIG. 10 shows the degree of controllability—at a constant pressure (100 psi or 689 kPa), for example, the spray angles can be varied from about 55° degrees down to a spray angle of about 25° in FIG. 13. FIGS. 11 and 13 show the same nozzle system 200, both with overall pressure at 100 psi (689 kPa). FIG. 11 shows the spray when 100% of the flow is through only one channel, for example and FIG. 13 shows the spray when the flow is split roughly evenly between the two flow channels 204 and 205. There can be a slight skew on individual injection points present at low flow rates when the channels are fed from a single side, meaning the ante-chamber is fed by only one channel 204. However, since nozzle system 200 is a multi-point design, the overall injector will not be skewed if individual points are all skewed the same way. A cross-section of the multi-point spray of FIG. 11 perpendicular to the nozzle is depicted schematically in FIG. 12, at a point in the spray cones where the cones just begin to meet, where the spray cone cross-sections are approximated by rings. FIG. 14 shows a similar view for the narrower spray angle of FIG. 13. FIG. 16 illustrates the same cross-section schematically for the full active spray cone of FIG. 15.

A method of issuing a spray cone from a nozzle includes modulating flow to two separate first and second fluid circuits, each connected to a common injection point orifice, e.g. injection point orifice 208, to vary spray angle on a substantially hollow spray cone over time to create a full spray cone. Modulating can include controlling first and second flow modulators, e.g., flow modulators 216 and 218, connected to the first and second fluid circuits, respectively, to coordinate oscillating flow rate modulation of both of the first and second fluid circuits. Controlling can include controlling the oscillating flow rate modulation for the first flow modulator to be out of phase with, to be in antiphase with, to be vertically shifted in magnitude relative to, and/or to have an amplitude that is equal to that of the second flow modulator as described above.

Traditional swirl type injectors produce a hollow cone. However, a solid cone of atomized liquid, as provided by the full active spray cone disclosed herein, is desirable in that it can distribute over a larger area, thus having quicker evaporation rates than traditional injectors and nozzles. In the exemplary context of fuel combustion, this can provide a more distributed flame than traditional injection techniques. This can result in substantially reduced emissions, increased operability, and more uniform temperature distributions which can improve engine life.

Spray angle control as described herein provides the potential for improved advanced active combustion control. Since the spray angle can be controlled fluidically instead of mechanically, a faster response time can be achieved than in other active combustion control devices. This can be realized by changing the spray angles in a controlled method to counteract unwanted thermal-acoustic instabilities, i.e. rumble, without the need to change the overall mass flow rate of the injector, but instead by simply adjusting the flow splits between flow channels. Additionally, due to the fluidic control of exemplary embodiments described herein, it may be possible to find a fluidically controllable instability, which could also be used to control the unwanted thermal-acoustic instabilities.

While described above in the exemplary context of fuel injection, those skilled in the art will readily appreciate that any suitable fluid can be swirled as described above. For example, the principles used to swirl fluids in nozzle system 200 can similarly be used for controlling air. In such applications, air is split into two separate inlet chambers, which respectively feed into similarly oriented directional passages. This allows for the air flow angle to be controlled fluidically, very similar to the way the liquid spray angle is controlled in nozzle system 200. Any other exemplary spray application can benefit from the systems and methods described herein without departing from the scope of this disclosure, including for example fuel cell reformers or exhaust gas after treatment, so the catalyst can receive a uniform distribution of fluid, fire sprinkler systems, agricultural sprayers, chemical processing, paint sprayers, and the like. Fluids such ad fuel, air, gas, oil, paint, water, or any other suitable fluid can be issued using the systems and methods described herein.

While shown and described above in the exemplary context of fuel injection for gas turbine engines, those skilled in the art will readily appreciate that any suitable fluids can be used and that any other suitable applications can make use of nozzles and injectors as described herein without departing from the spirit and scope of this disclosure. While described above in the exemplary context of multi-point injection, those skilled in the art will readily appreciate that any suitable number of injection points can be used, including single point injection, without departing from the spirit and scope of this disclosure.

The methods and systems of the present disclosure, as described above and shown in the drawings, provide for injection with superior properties including active full spray cones. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A nozzle system for injecting liquid comprising:
a nozzle body defining a first circuitous flow channel and a swirl ante-chamber in fluid communication with the first flow channel, with an injection point orifice defined in the swirl ante-chamber, wherein the first flow channel feeds into the swirl ante-chamber to impart a tangential flow component on fluids entering the swirl ante-chamber to generate swirl on a spray issuing from the injection point orifice, wherein a second circuitous flow channel s defined in fluid communication with the swirl ante-chamber, wherein the second flow channel feeds into the swirl ante-chamber to impart a tangential flow component on fluids entering the swirl ante-chamber;
a backing member in fluid communication with the nozzle body, the backing member including a first fluid inlet chamber having one or more flow passages defined through the backing member for fluid communication from the first fluid inlet chamber of the backing member to the first flow channel of the nozzle body, and a second fluid inlet chamber having one or more flow passages defined through the backing member for fluid communication from the second fluid inlet chamber of the backing member to the second flow channel of the nozzle body to change spray angle of the injection point orifice by apportionment of flow between the first and second fluid inlet chambers of the backing member;
a first flow modulator in fluid communication with the first fluid inlet; and
a second flow modulator in fluid communication with the second fluid inlet, wherein the first and second flow modulators are configured to issue an oscillating flow to the first and second fluid inlets, respectively, to issue a full active spray cone from the injection point orifice.

2. The nozzle system as recited in claim 1, further comprising a controller operatively connected to the first and second flow modulators to coordinate oscillating flow rate modulation of both.

3. The nozzle system as recited in claim 2, wherein the oscillating flow rate modulation for the first flow modulator is out of phase with the oscillating rate flow modulation for the second flow modulator.

4. The nozzle system as recited in claim 3, wherein the oscillating flow rate modulation for the first flow modulator is in antiphase with the oscillating flow rate modulation for the second flow modulator.

5. The nozzle system as recited in claim 2, wherein the oscillating flow rate modulation for the first flow modulator is vertically shifted in magnitude relative to the oscillating flow rate modulation for the second flow modulator.

6. The nozzle system as recited in claim 2, wherein the oscillating flow rate modulation for the first flow modulator has an amplitude that is equal to that of the second flow modulator.

7. The nozzle system as recited in claim 2, wherein the oscillating flow rate modulation for the first flow modulator is in antiphase with, is vertically shifted in magnitude relative to, and has an amplitude that is equal to that of the second flow modulator.

8. The nozzle system as recited in claim 1, wherein the flow passages of the first and second flow channels feed into the swirl ante-chamber to impart a counter-swirling tangential flow component on fluids entering the swirl ante-chamber.

9. The nozzle system as recited in claim 1, further comprising additional swirl ante-chambers, each having a separate injection point orifice, each swirl ante-chamber being in fluid communication with the first and second flow channels.

10. A method of issuing a spray cone from a nozzle comprising:
modulating flow to two separate first and second fluid circuits, each connected to a common injection point orifice to vary spray angle on a substantially hollow spray cone over time to create a full spray cone.

11. The method as recited in claim 10, wherein modulating includes controlling first and second flow modulators, connected to the first and second fluid circuits, respectively, to coordinate oscillating flow rate modulation of both of the first and second fluid circuits.

12. The method as recited in claim 11, wherein controlling includes controlling the oscillating flow rate modulation for the first flow modulator to be out of phase with the oscillating rate flow modulation for the second flow modulator.

13. The method as recited in claim 12, wherein controlling includes controlling the oscillating flow rate modulation for the first flow modulator to be in antiphase with the oscillating rate flow modulation for the second flow modulator.

14. The method as recited in claim 11, wherein controlling includes controlling the oscillating flow rate modulation for the first flow modulator to be in antiphase with, to be vertically shifted in magnitude relative to, and to have an amplitude that is equal to that of the second flow modulator.
